(19) United States
(12) Patent Application Publication
(10) Pub. No.: US 2015/0287069 A1
(43) Pub. Date: Oct. 8, 2015

(54) PERSONAL DIGITAL ENGINE FOR USER EMPOWERMENT AND METHOD TO OPERATE THE SAME

(71) Applicant: BE Energy Co. Limited, Hong Kong (CN)

(72) Inventors: Raimondo Andrea GISSARA, Shanghai (IT); Luther Edward JONES, Shanghai (GB)

(73) Assignee: BE Energy Co. Limited, Hong Kong (CN)

(21) Appl. No.: 14/266,222

(22) Filed: Apr. 30, 2014

(30) Foreign Application Priority Data
Apr. 3, 2014 (CN) PCT/CN2014/074693

(51) Int. Cl. G06Q 30/02; G06F 17/30

(52) U.S. Cl. CPC G06Q 30/0231; G06F 17/30867

(57) ABSTRACT

A personal digital engine for personal engine for user empowerment includes content viewing or generating activities, and generate information including the user's content viewing or generating activities; a push content system configured to generate content according to the information including the user's content viewing or generating activities; a loyalty points system configured to generate loyalty points for the user according to the information including the user's content viewing or generating activities; a central processing system configured to interact with the pull content system, the push content system and the loyalty points system; a data storage configured to store the information including the user's content viewing or generating activities; and a user interface configured to display the information including the user's content viewing or generating activities.

### FIELD

This disclosure relates to systems and methods for user data processing, and in particular but not by way of limitation, relates to a person digital engine for user empowerment, and a method to operate the same.

### BACKGROUND

Consumer behavior is driven by interests and actions behind their interests. In a modern digital environment, consumers have more and more opportunities to keep in touch with their interests. Everyday consumers more and more follow what they like, no matter the places where they are and no matter how are engaging in their activities (for example through different devices): on a webpage, on a social network, on a blog, on a search engine such as google, baidu, yahoo, etc., on a mobile, on a tablet, on a TV, on their digital glasses, etc.

### SUMMARY

This disclosure relates to systems and methods for user data processing, and in particular but not by way of limitation, relates to a person digital engine for user empowerment, and a method to operate the same.

Some embodiments hereby disclosed relate to a pull content system for monitoring and processing content from a user's content viewing or generating activities and generating information relevant to the user's content viewing or generating activities, and a method to operate the same. Some embodiment hereby disclosed relate to a push content system for generating content from a user's content viewing or generating activities, and a method to operate the same. Some embodiments hereby disclosed relate to a loyalty points system for generating loyalty points for a user according to the user's content viewing or generating activities, and a method to operate the same.

Particular embodiments include a personal digital engine for personal engine for user empowerment. The personal digital engine includes a pull content system configured to monitor and process content from a user's content viewing or generating activities, and generate information including the user's content viewing or generating activities; a push content system configured to generate content according to the information including the user's content viewing or generating activities; a loyalty points system configured to generate loyalty points for the user according to the information including the user's content viewing or generating activities; a central processing system configured to interact with the pull content system, the push content system and the loyalty points system; a data storage configured to store the information including the user's content viewing or generating activities; and a user interface configured to display the information including the user's content viewing or generating activities.

Some embodiments include a pull content system for monitoring and processing content from a user's content viewing or generating activities and generating information including the user's content viewing or generating activities. The pull content system includes a pull content monitor configured to monitor the content from the user's content viewing or generating activities; a pull content processor configured to process the content from the user's content viewing or generating activities and generate the information including a user's content viewing or generating activities; a pull content transmitter configured to transmit the information including the user's content viewing or generating activities; a central processing system configured to interact with the pull content system; a data storage configured to store the information including the user's content viewing or generating activities; and a user interface configured to display the information including the user's content viewing or generating activities.

Other embodiments include a push content system for generating content from a user's content viewing or generating activities. The push content system includes a push content transmitter configured to receive information including the user's content viewing or generating activities; a push content processor configured to search for content according to the information including the user's content viewing or generating activities; and a push content organizer configured to post content according to the information including the user's content viewing or generating activities; a central processing system configured to interact with the push content system; a data storage configured to store the information relevant to the user's content viewing or generating activities; and a user interface configured to display the information including the user's content viewing or generating activities.

Further embodiments include a loyalty points system for generating loyalty points for a user according to the user's content viewing or generating activities. The loyalty points system includes a loyalty points transmitter configured to receive information including the user's content viewing or generating activities; a loyalty points processor configured to generate loyalty points for the user based on the information including the user's content viewing or generating activities; and a loyalty points organizer configured to post loyalty points for the user based on the information including the user's content viewing or generating activities; a central processing system configured to interact with the loyalty points system; a data storage configured to store the information including the user's content viewing or generating activities; and a user interface configured to display the information including the user's content viewing or generating activities.

In some embodiments, a method for monitoring and processing content from a user's content viewing or generating activities and generating information including the user's content viewing or generating activities is disclosed. The method includes monitoring the content from a user's content viewing or generating activities; processing the content from a user's content viewing or generating activities and generate the information including the user's content viewing or generating activities; and transmitting the information including the user's content viewing or generating activities.

In other embodiments, a method for generating content from a user's content viewing or generating activities is disclosed. The method includes receiving information including the user's content viewing or generating activities; searching for content according to the information including the user's content viewing or generating activities; and posting content according to the information including the user's content viewing or generating activities.

In further embodiments, a method for generating loyalty points for a user according to the user's content viewing or generating activities is disclosed. The method includes receiving information including the user's content viewing or generating activities; generating loyalty points for the user based on the information including the user's content viewing or generating activities; and posting loyalty points for the user based on the information including the user's content viewing or generating activities.

The details of one or more embodiments are set forth in the accompanying drawings and the description below. Other features, objects and advantages of the embodiments will be apparent from the description and drawings, and from the claims.

### BRIEF DESCRIPTION OF THE DRAWINGS

The following is a brief explanation of embodiments herein using drawings and embodiments:

FIG. 1 is a block diagram of a system for a personal digital engine for user empowerment.

FIG. 2 is a block diagram of a pull content system.

FIG. 3 is a flow chart representing the steps to operate the pull content system.

FIG. 4 is a block diagram of a push content system.

FIG. 5 is a flow chart representing the steps to operate the push content system.

FIG. 6 is a block diagram of a loyalty points system.

FIG. 7 is a flow chart representing the steps to operate the loyalty points system.

### DETAILED DESCRIPTION

This disclosure relates to systems and methods for user data processing, and in particular but not by way of limitation, relates to a person digital engine for user empowerment, and a method to operate the same.

When used herein, the term “user empowerment” refers generally to the result of an increased level of engagement of the user in his/her interests and increased capability to access customized information, to influence exchanges about user interests and to gain potential advantages related to user interests. The term “hashtag or hangtags” refers to content following a hash symbol (“#”) or hash tags. It may be used to identify metadata tag. Words in messages on microblogging and social networking services such as Facebook, Google Plus, Instagram, Twitter and Weibo may be tagged by putting “#” before them. Content immediately following the hashtag (#) may be considered “tagged”. The term “tag or tags” refers to tags words or symbols describing interests, activities, brands, general categories of goods and services. Tags may be predetermined by the personal digital engine, or may be added by user from time to time during his/her use of the personal digital engine.

The development of digital devices is changing the capability of a consumer to interact with his/her interests. Digital devices allow consumers to exchange information about their interests, to buy products and services related to their interests, and more. This multitude of devices is multiplying the opportunities to define consumers' behavior and their interests. Behaviors and interests can be monitored and analyzed in more and more detailed ways by crossing data and by correlating information. The more the data about consumer interests is collected and detailed, the more such data becomes relevant to define the profiles of consumers.

The combination of multiple digital devices and social networks further enlarges the capability of consumers to share information about their interests, to get in touch with people with same interests, and to engaging in more concerted activities. By generating actions, consumers engage resources (including time, money, know-how, passions, etc.). This engagement leads into the concept of consumer empowerment, stemming from the interrelated activities of consumers from influencing and being influenced by other consumers.

In the past people used to talk about consumer empowerment, but the reality is that “consumer” is not anymore the right definition in the digital age. Consumer is a notion connected to a pure capability to purchase. Today this capability has already extended to sharing information, likes and dislikes, checking information, voting, etc. Therefore, in current world filled with digital devices interconnected by social networks, a consumer is not only recognized for his/her purchasing power, but also for his/her influence in social networks and engagements, etc. Such a consumer more and more becomes a user, and consequently the notion of user empowerment evolves.

User empowerment is the result of the intensity of a user's engagement behind specific interests, as well as the result of the capability to amplify the influence of his/her actions through social networks. Digital devices are extending the capability to collect data (and variety of data) about a user's experience. Data defines behaviors, habits and paths which users are following in their daily experiences.

Higher quantity and quality of user data are required by private and public entities in order to increase their capability to target specific users and to customize their experiences. Data becomes an essential tool to improve user experience. Therefore, the capability to collect user data, to make it accessible, to analyze and to display it on a user-interface becomes more and more important.

Collecting and making use of sensitive user data may invade user's privacy. There is a growing request of transparency from the users during the user empowerment process. Users are requiring higher awareness about what and how data is collected on the user's experience. A user's informed consent on whether his/her data is collected, how his/her data is collected, and in which way his/her data may be used is crucial in the user empowerment process. It is believed that more transparency on the collection and the use of user data may empower the user more, and may generate a final win-win situation with third parties like commercial brands and research institutions.

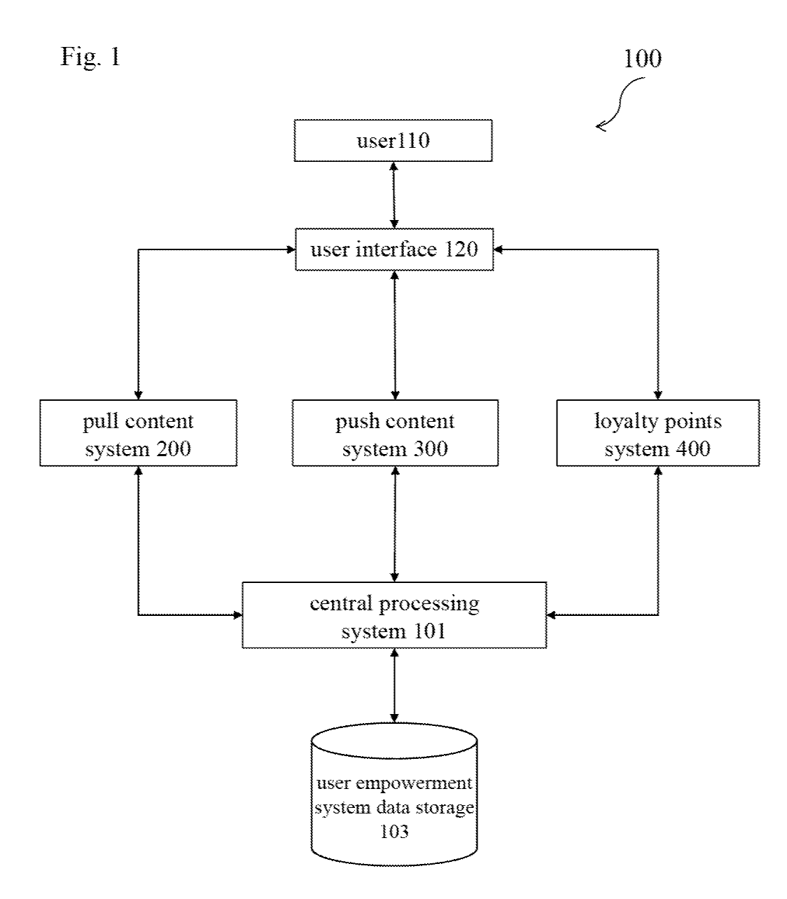

As shown in FIG. 1, in one embodiment the personal digital engine for user empowerment 100 may include a pull content system 200, a push content system 300, and a loyalty points system 400.

In one embodiment the pull content system 200, the push content system 300, and the reward system 400 may interact with one or more users 110 via a user interface 120. In one embodiment, the user 110 may be required to complete a registration process to obtain an identification code and a password in order to access his/her personal account as well as to operate the personal digital engine for user empowerment 100. In another embodiment, the user's personal account may be configured to link with the user's social network accounts, including, for example, Facebook account, Twitter account, Pinterest account, Weibo account, etc.

In one embodiment, the user interface 120 may be any user interface existing in the personal digital device marketplace, including but not limited to desktops, laptops, tablets, mobile phones, digital watches, TV, digital glasses, 2D and 3D printing, plasma screen, touch screen, projector, remote control imaging, 3D projection, voice commands, etc., as well as other forms of user interface yet conceptualized or marketed but nonetheless capable in carrying out the user-communication functions intended by the personal digital engine for user empowerment 100. In one embodiment, the user interface 120 contains an interactive portion where the user 110 may visualize his/her activities associated with the use of the personal digital engine for user empowerment 100. The interactive portion may be, for example, a sidebar browser extension or stand alone window visualizing banners on a computer screen, a notification window on mobile devices, a pull-down menu activated by a swipe on a touch screen, a pop-up portion of a television activated by a command from the remote control or by a voice command or a detected body movement, etc. In other embodiments, the interactive portion may be in other forms yet conceptualized or marketed but nonetheless capable in carrying out the user-communication functions intended by the personal digital engine for user empowerment 100. In another embodiment, the interactive portion may further include a window where the user 110 may send a message to his/her social networks of which the accounts are linked with the user's account of the personal digital engine for user empowerment 100.

In one embodiment the pull content system 200, the push content system 300, and the loyalty points system 400 may be configured to connect with a central processing system 101. In one embodiment the central processing system 101 may communicate with the pull content system 200, the push content system 300, and the loyalty points system 400, to collect data and relevant information and to provide instructions to the pull content system 200, the push content system 300, and the loyalty points system 400. In one embodiment, the central processing system 101 may be configured to communicate with the pull content system 200, the push content system 300, and the loyalty points system 400 over the Internet. Alternatively the Internet may not be relied, and the central processing system 101 may be configured to communicate with the pull content system 200, the push content system 300, and the loyalty points system 400 via other forms of wired or wireless communication channels, including, for example, any form of Bluetooth connection, near field communication, Ethernet, infrared ray, mobile telecom lines, etc. In one embodiment a system administrator 102 authorized by the personal digital engine for user empowerment 100 may access the central processing system 101, using digital encryption measures like traditional pass code, finger print lock, voice recognition, etc. In one embodiment the system administrator 102 may be authorized by the personal digital engine for user empowerment system 100 to access user 110 data, to make modifications to or overwrite user 110 data, or to take other actions to maintain or upgrade the personal digital engine for user empowerment system 100.

In another embodiment a personal engine for user empowerment system data storage 103 may be configured to connect with the central processing system 101. In one embodiment, the central processing system 101 may upload information onto the personal engine for user empowerment system data storage 103, and may download information from the personal engine for user empowerment system data storage 103. In one embodiment, the personal engine for user empowerment system data storage 103 may be in any traditional form including hard drive, server, flash drive, compact disc, cloud storage system, etc. Alternatively, the personal engine for user empowerment system data storage 103 may be in other forms of data storage yet conceptualized or marketed nonetheless capable of carrying out data storing functions intended by the personal digital engine for user empowerment system 100. In one embodiment the personal engine for user empowerment system data storage 103 may contain user information of users 110 using the personal digital engine for user empowerment system 100. In another embodiment the personal engine for user empowerment system data storage 103 may also contain information relevant to the users' 110 activities associated with their use of the personal digital engine for user empowerment system 100, including, for example, relevant content provided by third parties, and promotional information from third parties which may specifically interest a group of users 110.

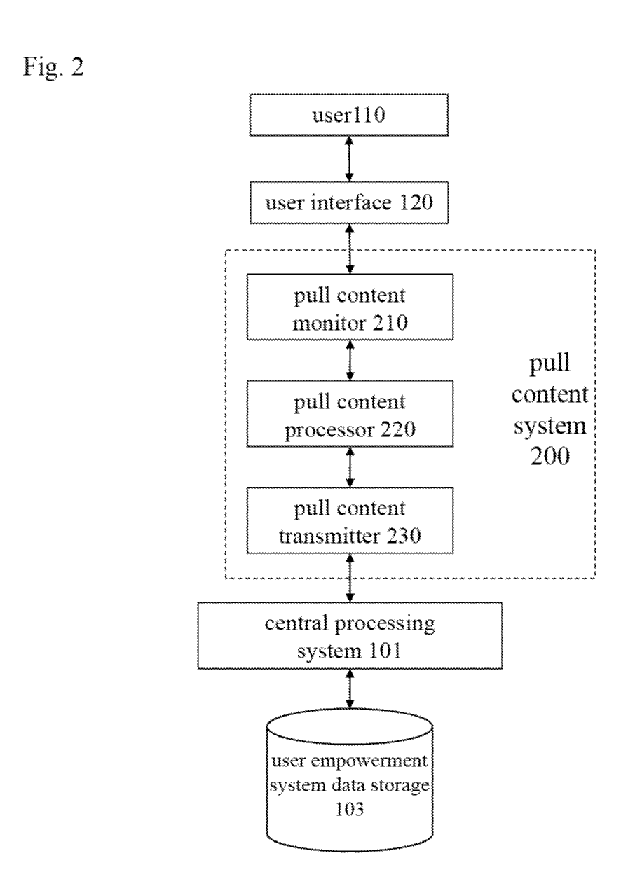

As shown in FIG. 2, in one embodiment the pull content system 200 may include a pull content monitor 210, a pull content processor 220, and a pull content transmitter 230. In one embodiment the pull content system 200 may be configured to interact with the user 110 via the user interface 120. In another embodiment the pull content system 200 may further be configured to connect with the central processing system 101 which may be accessible by the system administrator 102 and may further connect with the personal engine for user empowerment system data storage 103.

In one embodiment, the pull content system 200 may monitor content the user 110 is viewing or is generating, identify hashtags and tagged content within the content viewed or generated by the user 110, process the description of the tagged content according to a predefined set of metadata (tags) and the repetition of the tagged content, sort out individual tags and count the number of occasions where the tagged content is categorized under the tag (i.e. the frequency of the tag), create correlations of tags relevant for the user's on-going experience and transmit user information relating to a certain tag and correlated tags (including the number of occasions where a tagged content is categorized under the tag, i.e. the frequency of the tag) to the central processing system 101 after being processed. For example, in one embodiment the pull content system 200 may monitor the user 110 using his/her mobile device, and identify that the user 110 is typing in a hashtag “#basketball” on the screen of his/her mobile device. The pull content system 200 may distinguish the tagged content “basketball”, and thereafter count the number of occasions the hashtag “#basketball” which was used, is being using, and will be used by the user 110 on different end-user devices he/she has linked to the personal digital engine for user empowerment 100, including for example his/her personal computer, tablets, digital watch, digital glasses, TV, etc. Alternatively, the pull content system may also count the number of occasions the hashtags related to basketball including for example “#soccer” or “#hockey” which were used, are being using, and will be used by the user 110 on different end-user devices he/she has linked to the personal digital engine for user empowerment 100

In one embodiment, the pull content system 200 may further communicate with the central processing system 101 by transmitting user data and other relevant information to and from the central processing system 101. In one embodiment, user data and other relevant information may be further uploaded to the personal engine for user empowerment system data storage 103. Alternatively the user data and other relevant information may further be downloaded from the personal engine for user empowerment system data storage 103.

In one embodiment, content the user 110 is viewing may be in any format including text, image, video, audio, etc. In one embodiment, content the user 110 is generating may be in any format including input characters, words and phrases, sound or video clips, or body movements, etc.

In one embodiment, the tags used in the personal digital engine for user empowerment system 100 may be in any form including various letters, shapes, labels, sound, colors, etc., and any combination of such letters, shapes, labels, sound, colors, etc. In one embodiment, the tags may be words describing interests, activities, brands, general categories of goods and services. For example, in one embodiment, the tag may be “sports”, which may correlate various sports related goods and services such as “basketball”. When the content viewed or generated by the user 110 contains the tagged content “basketball” within a hashtag (for example “#Nike-basketball”), the pull content monitor 210 may identify the hashtag (“#Nike-basketball”) and the tagged content (“basketball”), and its correlations with other hashtag like sports or others (for example “#soccer”). Subsequently, in one embodiment the pull content processor 220 may process the description of the tagged content “basketball”, and may categorize the tagged content “basketball” under the tag “sports”. In one embodiment, the pull content processor 220 may also count the number of occasions where the tagged content is categorized under the tag “sports” (i.e. the frequency of the tag “sports”, including for example the frequency of the tag “basketball” and the tag “soccer”). In one embodiment the pull content transmitter 230 may further send user information relevant to the tag “sports” (including the number of occasions where a tagged content is categorized under the tag “sports”, i.e. the frequency of the tag “sports” including for example the frequency of the tag “basketball” and the tag “soccer”) to the central processing system 101. Alternatively the user information may be further uploaded and stored in the personal engine for user empowerment system data storage 103, available for downloading and further processing.

In one embodiment, tags may be a predetermined set of terms defining general categories of activities, items, goods, services, etc. In another embodiment, tags may be symbols and phrases frequently used by the users 110, regardless of their end-user devices or platforms. In one embodiment, the central processing system 101 may compare and analyze massive data generated from a number of users 110, and may identify those symbols or phrases that are most frequently used by users 110 in tagged content. The central processing system 101 may generate tags according to the processed user information, or it may recommend potential tags to the system administrator 102 for his/her approval. In one embodiment, the system administrator 102 may determine whether to include recommended potential tags into the personal digital engine for user empowerment 100, and may exclude or delete existing tags from the user empowerment system 100. In one embodiment, the system administrator 102 may consider legal prescriptions, public policy, cultural restrictions and commercial interests in his/her decision to include or exclude a tag into or from the personal digital engine for personal engine for user empowerment 100.

For example, in one embodiment, the tags may be created by the system administrator 102 by using the concept of wordnet. In one embodiment, a tag may be created by including the same synsets of the word in the tag. In one embodiment, the synsets of a certain word may include: (1) synonyms, which are equivalent words of the word in the tag, for example the tag “table” may include its synonym “desk”; (2) hyponyms, which are words “underneath” the word in the tag, for example the tag “table” may include its hyponym “table surface”; and (3) hypernyms, which are words “above” the word in the tag, for example the tag “table” may include its hyponym “furniture”. In another embodiment, the personal digital engine for user empowerment 100 may compare the tags created by using the concept of wordnet, for example the tag “table” to the existing tags in the personal digital engine for user empowerment 100. In one embodiment, the personal digital engine for user empowerment 100 may determine that the tag “table” has yet been added into personal digital engine for user empowerment 100, and may thereafter seek permission from the system administrator 102 to add the tag “table” 102 into the personal digital engine for user empowerment 100.

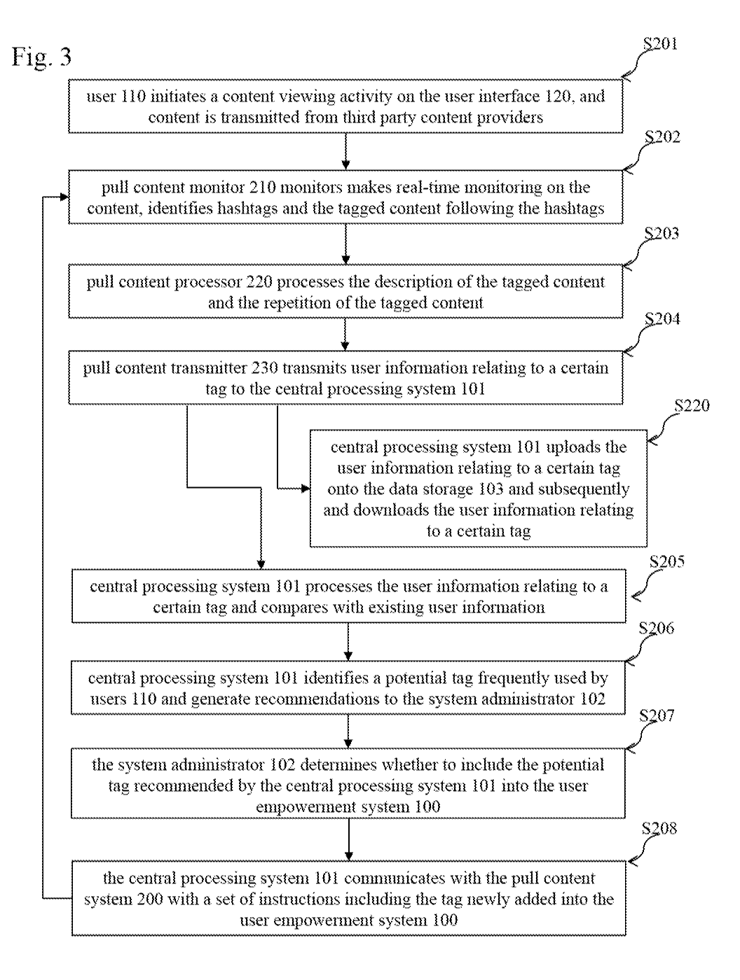

As further illustrated in FIG. 3, in one embodiment several steps are provided to operate the pull content system 200, which may include:

S201. the user 110 initiates a content viewing activity on the user interface 120 after accessing the personal digital engine for personal engine for user empowerment 100 using his/her username and password, and content is transmitted from third party content providers; the content contains different format including text, image, video, audio, and combinations of text, image, video, audio;

S202. following step S201, the pull content monitor 210 makes real-time monitoring on the content, identifies hashtags and correlated hashtags according to a specific system's algorithm and the tagged content following the hashtags and correlated hashtag;

S203. following step S202, the pull content processor 220 processes the description of the tagged content according to a specific algorithm based on rankings of hashtags determined by crossed information such frequency of hashtag usage in the user experience, etc.;

S204. following step S203, the pull content transmitter 230 transmits the user's user information relating to a certain hashtag and correlated hashtags (including the number of occasions where a tagged content is categorized under the tag, i.e. the frequency of the tag) to the central processing system 101 after being processed;

S205. following step S204, the central processing system 101 processes the user information relating to a certain hashtag and correlated hashtags (including the number of occasions where a tagged content is categorized under the tag, i.e. the frequency of the tag) transmitted from the pull content transmitter 230, and compares the newly received user information with existing user information;

S206. following step S205, the central processing system 101 identifies a potential hashtag and correlated hashtags frequently used by users 110 regardless of their end-user devices or platforms, and generate recommendations to the system administrator 102 to include the potential tag and correlated hashtags into the personal digital engine for user empowerment 100;

S207. following step S206, the system administrator 102 determines whether to include the potential tag recommended by the central processing system 101 into the personal digital engine for user empowerment system 100; if the system administrator 102 approves the recommendation, the system administrator 102 sends an instruction to the central processing system 101 to include the potential tag into the personal digital engine for user empowerment 100;

S208. following step S207, the central processing system 101 communicates with the pull content monitor 210, the pull content processor 220 and the pull content transmitter 230 with a set of instructions including the tag newly added into the personal digital engine for user empowerment 100; content viewed by the user 110 then is monitored, processed and user information transmitted using the instructions including the tag newly added into the personal digital engine for user empowerment 100;

S220. following step S204, the central processing system 101 uploads the user information relating to a certain tag (including the number of occasions where a tagged content is categorized under the tag, i.e. the frequency of the tag) onto the personal engine for user empowerment data storage 103, and subsequently downloads the user information relating to a certain tag (including the number of occasions where a tagged content is categorized under the tag, i.e. the frequency of the tag) from the personal engine for user empowerment data storage 103.

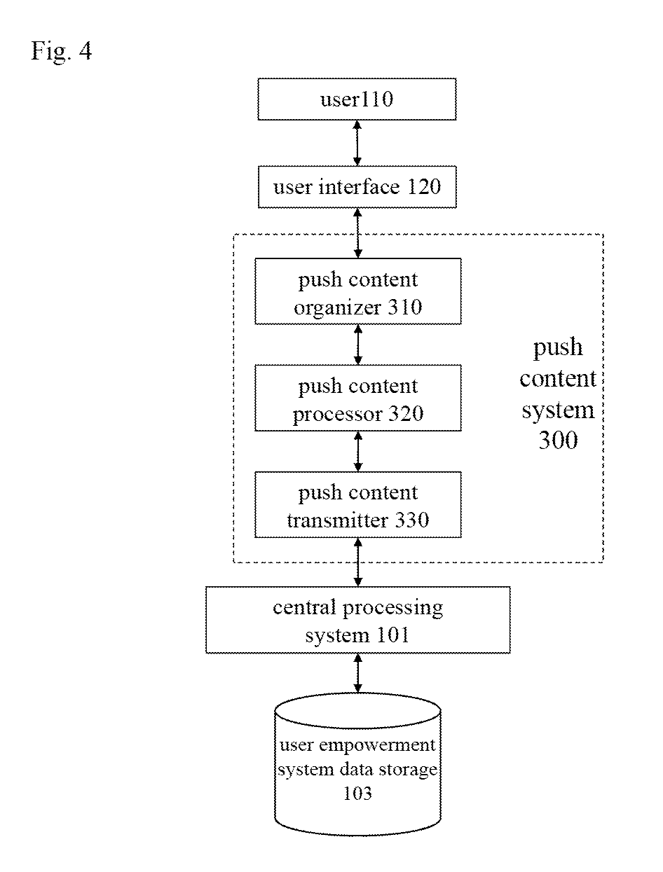

As shown in FIG. 4, in one embodiment the push content system 300 may include a push content organizer 310, a push content processor 320, and a push content transmitter 330. In one embodiment the push content system 300 may further interact with the user 110 via a user interface 120. In one embodiment the push content system 300 may be configured to connect with the central processing system 101, which may alternatively be accessible by the system administrator 102 and may further connect with the personal engine for user empowerment data storage 103.

In one embodiment, the push content transmitter 330 may receive a set of instructions from the central processing system 101, which may contain, among other things, a certain tag or a string of tags. The push content transmitter 330 may identify the tag or the string of tags, and communicate with the push content processor 320. According to the tags and strings of tags, specific sources could be “called” by the push content processor 320.

In one embodiment, the push content processor 320 may communicate with the content transmitter 330 and receives the information containing the tag or string of tags. The push content processor 320 may generate a set of parameters according to the tag or string of tags. In one embodiment, the push content processor 320 may use the set of parameters to search the Internet. In another embodiment, the push content processor may search the personal engine for user empowerment data storage 103. The push content processor 320 may identify content on the Internet or in the personal engine for user empowerment data storage 103 that is relevant to the tag or string of tags. In one embodiment, content relevant to the tag or string of tags may be in various forms including text, image, video, audio, and any combination of text, image, video, audio, etc. In one embodiment the push content processor 320 may generate a list of content relevant to the tag or string of tags, and send the list of content relevant to the tag or string of tags to the push content organizer 310.

In one embodiment the push content organizer 310 may communicate with the push content processor 320 and receives the list of content relevant to the tag or string of tags. The push content organizer 310 may access the Internet or the personal engine for user empowerment system data storage 103 in accordance with the list of content relevant to the tag or string of tags. The push content organizer 310 may repost the accessed content relevant to the tag or string of tags on the user interface 120. In one embodiment, the push content organizer 310 may repost content relevant to the tag or string of tags to the interactive portion of the user interface 120. In another embodiment, the push content organizer 310 may control the position, duration and style of the reposted content relevant to the tag or string of tags displayed on the user interface 120, in order to optimize user visualization and to attract additional user's attention. In another embodiment, the push content organizer 310 may arrange the sequence and combination of the content relevant to the tag or string of tags displayed on the user interface 120, in order to optimize user visualization and to attract additional user's attention.

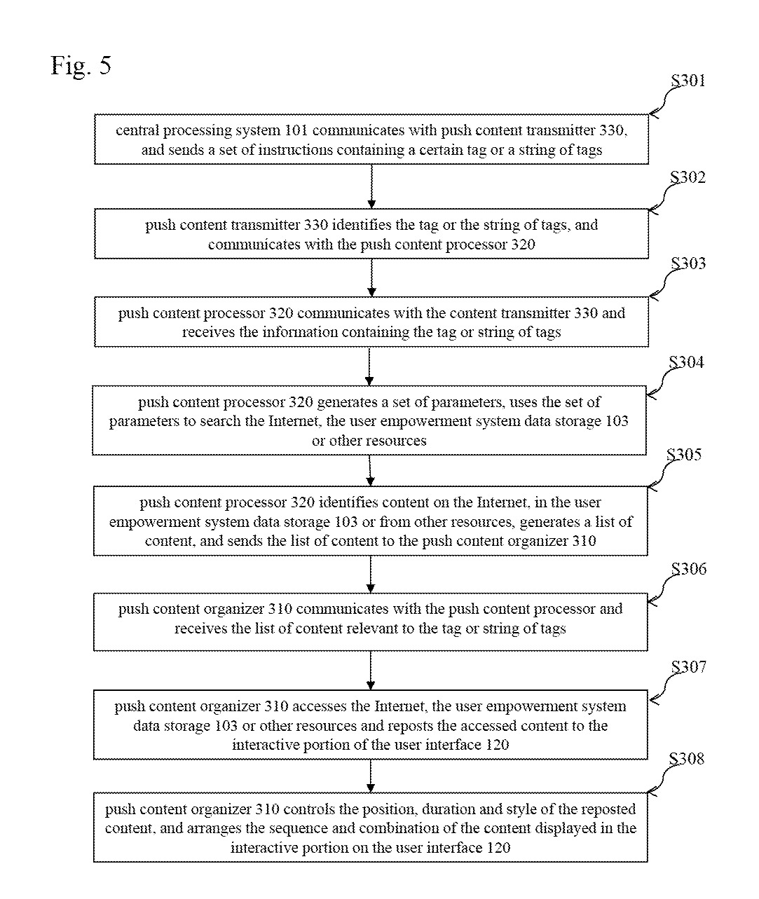

As further illustrated in FIG. 5, in one embodiment several steps are provided to operate the push content system 300, which may include:

S301. the central processing system 101 communicates with the push content transmitter 330, and sends a set of instructions containing a certain tag or a string of tags to the push content transmitter 330;

S302. following step S301, the push content transmitter 330 receives the set of instructions containing a certain tag or a string of tags from the central processing system 101, identifies the tag or the string of tags, and communicates with the push content processor 320;

S303. following step S302, the push content processor 320 communicates with the content transmitter 330 and receives the information containing the tag or string of tags;

S304. following S303, the push content processor 320 generates a set of parameters according to the tag or string of tags, and the push content processor 320 uses the set of parameters to search the Internet and the personal engine for user empowerment data storage 103;

S305. following step S304, the push content processor 320 identifies content from several sources connected to the system and in the personal engine for user empowerment data storage 103 which is relevant to the tag or string of tags, generates a list of content relevant to the tag or string of tags, and sends the list of content relevant to the tag or string of tags to the push content organizer 310;

S306. following step S305, the push content organizer 310 communicates with the push content processor 320 and receives the list of content relevant to the tag or string of tags;

S307. following step S306, the push content organizer 310 accesses the Internet or the personal engine for user empowerment data storage 103 in accordance with the list of content relevant to the tag or string of tags, and reposts the accessed content relevant to the tag or string of tags to the interactive portion of the user interface 120;

S308. following step S307, the push content organizer 310 controls the position, duration and style of the reposted content relevant to the tag or string of tags displayed in the interactive portion on the user interface 120, and arranges the sequence and combination of the content relevant to the tag or string of tags displayed in the interactive portion on the user interface 120.

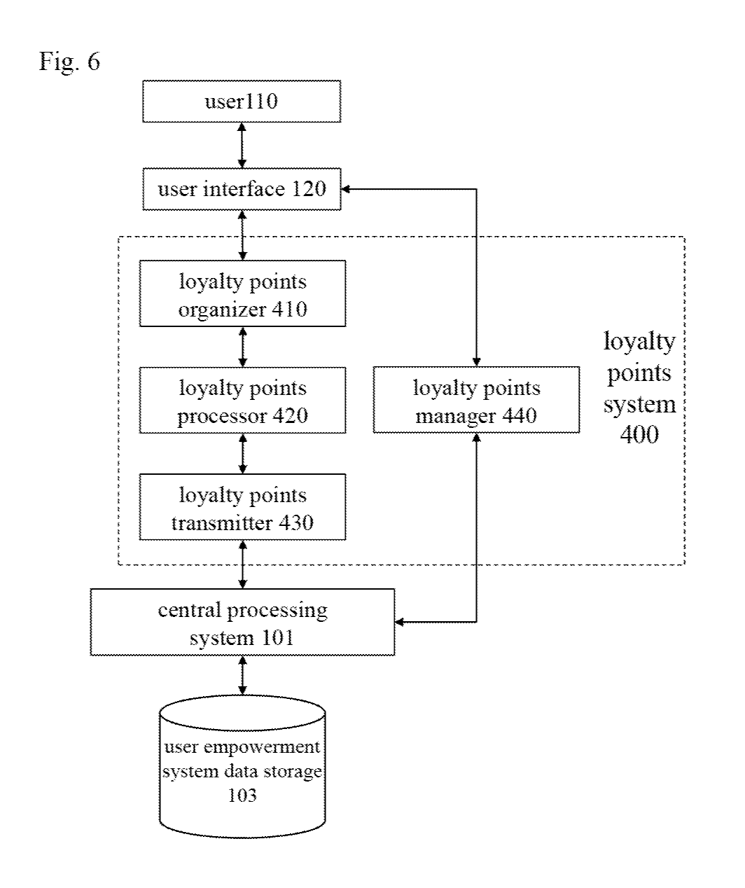

As shown in FIG. 6, in one embodiment the loyalty points system 400 may include a loyalty points organizer 410, a loyalty points processor 420, a loyalty points transmitter 430, and a loyalty points manager 440. The loyalty points system 400 may further be configured to interact with the user 110 via the user interface 120. The loyalty points system 400 may further be configured to connect with the central processing system 101 which may be accessible by the system administrator 102 and may further connect with the personal engine for user empowerment data storage 103.

In one embodiment, the loyalty points transmitter 430 may receive a set of instructions from the central processing system 101, which may contain, among other things, a certain tag or a string of tags, and may also contain the frequency of a certain tag associated with the user's content viewing or generating activities. The loyalty points transmitter 430 may identify the tag or the string of tags, and may also identify the frequency of a certain tag and correlated tags associated with the user's content viewing or generating activities. The loyalty points transmitter 430 may communicate with the loyalty points processor 420.

In one embodiment, the loyalty points processor 420 may communicate with the loyalty points transmitter 430 and receive the information containing the tag or string of tags as well as the frequency of a certain tag or correlated tags associated with the user's content viewing or generating activities. The loyalty points processor 320 may generate a definite amount of loyalty points for the user 110 according to the tag or string of tags as well as the frequency of a certain tag or correlated tags associated with the user's content viewing or generating activities. In one embodiment the loyalty points processor 420 may accumulate the user's loyalty points for his/her content viewing or generating activities using the personal digital engine for user empowerment 100 since the user 110 has established his/her user's account, and record the user's accumulated loyalty points. In one embodiment the loyalty points for the user 110 may be formatted and visualized by the user 110 as numerical symbols. In other embodiments the loyalty points for the user 110 may be formatted as other forms of messages including texts, images, videos, audio providing incentives for the user 110 to use the personal engine for user empowerment 100 more frequently and more extensively.

In one embodiment the loyalty points processor 420 may use a predefined set of base points parameters to generate a definite amount of loyalty points for the user 110 according to the tag or string of tags as well as the frequency of a certain tag or correlated tags associated with the user's content viewing or generating activities. In one embodiment, the set of base points parameters may identify the level of importance of a tag, and assign more loyalty points for a tag with a higher level of importance. In one embodiment the level of importance may depend on the frequency of interaction with the tag, the regular activities on it and other parameters. In one embodiment, the level of importance of a tag may be determined by the frequency of the tag used by relevant user community. In another embodiment, the level of importance of a tag may be set by the system administrator 102. The set of base points parameters may also recognize the frequency of a certain tag associated with the user's content viewing or generating activities, and may assign more loyalty points for a tag with higher frequency associated with the user's content viewing or generating activities. The amount of loyalty points earned by the user 110 according to the tag or string of tags as well as the frequency of a certain tag associated with the user's content viewing or generating activities, processed by the loyalty points processor 420 using the set of base points parameters may be identified as base loyalty points for the user 110.

For example, in one embodiment, the set of base points parameters may include the following: signing into the user's personal digital engine for user empowerment 100 account may generate 100 points; clicking a webpage which contains a certain hashtag may generate 10 points per click (in other embodiments the points generated from clicking the webpage may vary according to the exact portion of the webpage which is clicked, typically when the webpage is displayed in multi-window or certain user-interactive portions are created within the webpage); book-marking a webpage containing a certain hashtag which has yet been bookmarked may generate 100 points; sharing content containing a certain hashtag using the personal digital engine for user empowerment 100 to the user's one certain social network may generate 100 points; content containing a certain hashtag being reposted on the user's certain social network after being posted using the personal digital engine for user empowerment 100 may generate 100 points for each of the reposts. In other embodiment, other user content viewing or generating activities using the personal digital engine for user empowerment 100 may also generate loyalty points for the user 110, and the points generated from different user 110 content viewing or generating activities using the personal digital engine for user empowerment 100 may vary.

In one embodiment, the loyalty points processor 420 may establish a set of user levels, and assign a threshold amount of accumulated loyalty points of a certain user level for the user 110 to attain such user level. A certain user level may be attained by the user 110 when the user's accumulated amount of loyalty points reaches the threshold amount of loyalty points of such user level. In another embodiment, the user level may serve as a user level multiplier for the calculation of loyalty points. In another embodiment, the user's loyalty points earned for the user's content viewing or generating activities using the personal digital engine for user empowerment 100 may equal to the product of the user's base loyalty points and the user level multiplier. For example, in one embodiment when the user's accumulated loyalty points range from 0 to 9,999, the user's user level is 1. When the user's accumulated loyalty points range from 10,000 to 19,999, the user's user level is 2. When the user's accumulated loyalty points range from 20,000 to 29,999, the user's user level is 3. For every 10,000 loyalty points accumulated, the user's user level advances by one level. In above embodiment, the user level multiplier equals to numerical value of the user's user level. The loyalty points earned by the user 110 when viewing or generating or interacting with content using the personal engine for user empowerment 100 may equal to the base loyalty points the user 110 earned when viewing or generating or interacting with content, multiplied by the user's current user level. For example, if a user level II user 110, by viewing and generating content using the personal engine for user empowerment 100, earns 500 base loyalty points, the loyalty points earned from such content viewing and generating activities equal 1,000 (which is the user's base loyalty points 500 multiplied by the user level multiplier 2). In one embodiment the user level of the user 110 may be flexible. In another embodiment the user level of the user 110 may be changed according to system administrator's 102 decisions.

In one embodiment, the user level of the user 110 may diminish when lack of activities using the personal engine for user empowerment 100. In one embodiment, the user level of the user 110 may diminish because the user 110 misuses the personal engine for user empowerment 100. In another embodiment, in order to keep the multiplier level, the user 110 may have to keep regular activities related to that specific hashtag using the personal engine for user empowerment 100.

In one embodiment the loyalty points organizer 410 may communicate with the loyalty points processor 420, and receive the user's loyalty points information including the user's user level. In one embodiment, the loyalty points organizer 410 may post the user's loyalty points information including the user's user level on the user interface 120. In one embodiment, the loyalty points organizer 410 may post the user's loyalty points information including the user's user level in the interactive portion of the user interface 120. In another embodiment, the loyalty points organizer 410 may control the display of the position, duration and style of the user's loyalty points information including the user's user level on the user interface 120.

In one embodiment, the user 110 may visualize his/her loyalty points, and may access the loyalty points manager 440 to manage his/her loyalty points. In one embodiment, the loyalty points manager 440 may communicate with the central processing system 101. The loyalty points manager 440 may acquire the user 110 information from the central processing system 101. The user 110 information may contain tags frequently viewed or generated by the user 110. The loyalty points manager 440 may search third party promotional information relevant to the tags frequently viewed or generated by the user 110 on the Internet, in mobile applications activities or other devices activities, or in the personal engine for user empowerment data storage 103. The loyalty points manager 440 may post the third party promotional information or system administrator 102 promotional information relevant to the tags frequently viewed or generated by the user 110 on the user interface 120. In one embodiment the loyalty points manager 440 may convert user's loyalty points into credits or other incentives redeemable for discounts or other benefits applicable at third parties or at the system administrator 102, and may deduct the amount of loyalty points converted into credits or other incentives from the user's accumulated loyalty points.

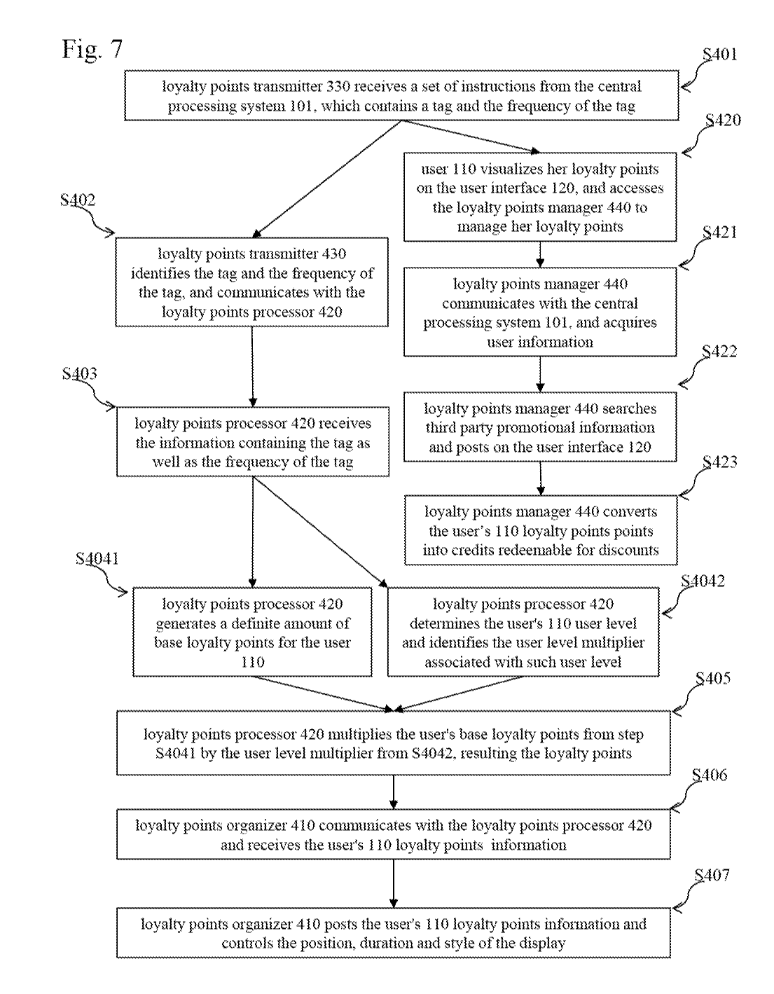

As further illustrated in FIG. 7, in one embodiment several steps are provided to operate the loyalty points system 400, which may include:

S401. the loyalty points transmitter 430 receives a set of instructions from the central processing system 101, which contains, among other things, a tag, and also contains the frequency and other parameters of the tag associated with the user's content viewing or generating activities;

S402. following step S401, the loyalty points transmitter 430 identifies the tag, and also identifies the frequency and other parameters of the tag associated with the user's content viewing or generating activities; the loyalty points transmitter 430 then communicates with the loyalty points processor 420;

S403. following S402, the loyalty points processor 420 communicates with the loyalty points transmitter 430 and receives the information containing the tag as well as the frequency and other parameters of the tag associated with the user's content viewing or generating activities;

S4041. following step S403, using a predefined set of base points parameters, the loyalty points processor 420 generates a definite amount of base loyalty points for the user 110 according to the tag as well as the frequency and other parameters of the tag associated with the user's content viewing or generating activities, and formats base loyalty points visualized as symbols by the user 110;

S4042. following step S403, the loyalty points processor 420 determines the user's user level by examining whether the user's accumulated loyalty points have reached the threshold amount established for a certain user level, and identifies the user level multiplier associated with such user level;

S405. following step S4041 and step S4042, the loyalty points processor 420 multiplies the user's base loyalty points from step S4041 by the user level multiplier from S4042, and the product of the user's base loyalty points from step S4041 and the user level multiplier from S4042 is the user's loyalty points for the user's content viewing and generating activities;

S406. following step S405, the loyalty points organizer 410 communicates with the loyalty points processor 420 and receives the user's loyalty points information from steps S4041 and S405, including the user's user level;

S407. following step S406, the loyalty points organizer 410 posts the user's loyalty points information from steps S4041 and S405, including the user's user level in the interactive portion of the user interface 120, and controls the position, duration and style of the display of the user's loyalty points information from steps S4041 and S405, including the user's user level;

S420. following step S401, the user visualizes his/her loyalty points on the user interface 120, and accesses the loyalty points manager 440 to manage his/her loyalty points;

S421. following step S420, the loyalty points manager 440 communicates with the central processing system 101, and acquires the user's user information containing tags frequently viewed or generated by the user 110 from the central processing system 101;

S422. following step S421, the loyalty points manager 440 searches third party promotional information or system administrator 102 information relevant to the tags frequently viewed or generated by the user 110 on the Internet and in the personal engine for user empowerment data storage 103, and posts the third party promotional information relevant to the tags frequently viewed or generated by the user 110 on the user interface 120;

S423. following step S422, the loyalty points manager 440 converts the user's accumulated loyalty points into credits redeemable for discounts applicable at third parties, and deducts the amount of loyalty points converted into credits or other incentives from the user's accumulated loyalty points.

The following paragraphs describe various embodiments herein. It is noted that any of paragraphs 1-5 below can be combined with any of paragraphs 6-7, any of paragraphs 8-9, any of paragraphs 10-11, paragraph 12, paragraph 13 and paragraph 14. Also, any of paragraphs 6-7 below can be combined with any of paragraphs 8-9, any of paragraphs 10-11, paragraph 12, paragraph 13 and paragraph 14. Moreover, any of paragraphs 8-9 below can be combined with any of paragraphs 10-11, paragraph 12, paragraph 13 and paragraph 14. Further, any of paragraphs 10-11 below can be combined with paragraph 12, paragraph 13 and paragraph 14. In addition, paragraph 12 below can be combined with paragraph 13 and paragraph 14. In further addition, paragraph 13 below can be combined with paragraph 14.

1. A personal digital engine for personal engine for user empowerment, comprising:

a pull content system configured to monitor and process content from a user's content viewing or generating activities, and generate information including the user's content viewing or generating activities;

a push content system configured to generate content according to the information including the user's content viewing or generating activities;

a loyalty points system configured to generate loyalty points for the user according to the information including the user's content viewing or generating activities;

a central processing system configured to interact with the pull content system, the push content system and the loyalty points system;

a data storage configured to store the information including the user's content viewing or generating activities; and

a user interface configured to display the information including the user's content viewing or generating activities.

2. The system in paragraph 1, wherein:

the information including the user's content viewing or generating activities is identified by hashtags; and

the hashtags are processed by the personal digital engine according to tags.

3. The system in any of paragraphs 1-2, wherein:

the tags are a set of terms defining one or more categories selected from the group consisting of interests, activities, items, goods, services and brands.

4. The system in any of paragraphs 1-2, wherein:

the tags are a set of terms predetermined or added by user during the use of the personal digital engine.

5. The system in any of paragraphs 1-2, wherein:

the tags are symbols and phrases frequently used by the user or linked to the user's content viewing or generating activities.

6. A pull content system for monitoring and processing content from a user's content viewing or generating activities and generating information including the user's content viewing or generating activities, comprising:

a pull content monitor configured to monitor the content from the user's content viewing or generating activities;

a pull content processor configured to process the content from the user's content viewing or generating activities and generate the information including a user's content viewing or generating activities;

a pull content transmitter configured to transmit the information including the user's content viewing or generating activities;

a central processing system configured to interact with the pull content system;

a data storage configured to store the information including the user's content viewing or generating activities; and

a user interface configured to display the information including the user's content viewing or generating activities.

7. The pull content system in paragraph 6, wherein:

the information including the user's content viewing or generating activities is identified by hashtags; and

the hashtags are processed by the personal digital engine according to tags.

8. A push content system for generating content from a user's content viewing or generating activities, comprising:

a push content transmitter configured to receive information including the user's content viewing or generating activities;

a push content processor configured to search for content according to the information including the user's content viewing or generating activities; and

a push content organizer configured to post content according to the information including the user's content viewing or generating activities;

a central processing system configured to interact with the push content system;

a data storage configured to store the information relevant to the user's content viewing or generating activities; and

a user interface configured to display the information including the user's content viewing or generating activities.

9. The push content system in paragraph 8, wherein:

the information including the user's content viewing or generating activities is identified by the hashtags; and

the hashtags are processed by the personal digital engine according to tags.

10. A loyalty points system for generating loyalty points for a user according to the user's content viewing or generating activities, comprising:

a loyalty points transmitter configured to receive information including the user's content viewing or generating activities;

a loyalty points processor configured to generate loyalty points for the user based on the information including the user's content viewing or generating activities; and

a loyalty points organizer configured to post loyalty points for the user based on the information including the user's content viewing or generating activities;

a central processing system configured to interact with the loyalty points system;

a data storage configured to store the information including the user's content viewing or generating activities; and

a user interface configured to display the information including the user's content viewing or generating activities.

11. The loyalty points system in paragraph 10, wherein:

the information including the user's content viewing or generating activities is identified by hashtags; and

the hashtags are processed by the personal digital engine according to tags.

12. A method for monitoring and processing content from a user's content viewing or generating activities and generating information including the user's content viewing or generating activities, comprising:

monitoring the content from a user's content viewing or generating activities;

processing the content from a user's content viewing or generating activities and generate the information including the user's content viewing or generating activities; and

transmitting the information including the user's content viewing or generating activities.

13. A method for generating content from a user's content viewing or generating activities, comprising:

receiving information including the user's content viewing or generating activities;

searching for content according to the information including the user's content viewing or generating activities; and

posting content according to the information including the user's content viewing or generating activities.

14. A method for generating loyalty points for a user according to the user's content viewing or generating activities, comprising:

receiving information including the user's content viewing or generating activities;

generating loyalty points for the user based on the information including the user's content viewing or generating activities; and

posting loyalty points for the user based on the information including the user's content viewing or generating activities.

A number of embodiments of the invention have been described. Nevertheless, it will be understood that various modifications may be made without departing from the spirit and scope of the invention. Accordingly, other embodiments are within the scope of the following claims.

What is claimed is:

1. A personal digital engine for personal engine for user empowerment, comprising:
a pull content system configured to monitor and process content from a user's content viewing or generating activities, and generate information including the user's content viewing or generating activities;
a push content system configured to generate content according to the information including the user's content viewing or generating activities;
a loyalty points system configured to generate loyalty points for the user according to the information including the user's content viewing or generating activities;
a central processing system configured to interact with the pull content system, the push content system and the loyalty points system;
a data storage configured to store the information including the user's content viewing or generating activities; and
a user interface configured to display the information including the user's content viewing or generating activities.

2. The system in claim 1, wherein:
the information including the user's content viewing or generating activities is identified by hashtags; and
the hashtags are processed by the personal digital engine according to tags.

3. The system in claim 2, wherein:
the tags are a set of terms defining one or more categories selected from the group consisting of interests, activities, items, goods, services and brands.

4. The system in claim 2, wherein:
the tags are a set of terms predetermined or added by user during the use of the personal digital engine.

5. The system in claim 2, wherein:
the tags are symbols and phrases frequently used by the user or linked to the user's content viewing or generating activities.

6. A pull content system for monitoring and processing content from a user's content viewing or generating activities and generating information including the user's content viewing or generating activities, comprising:
a pull content monitor configured to monitor the content from the user's content viewing or generating activities;
a pull content processor configured to process the content from the user's content viewing or generating activities and generate the information including a user's content viewing or generating activities;
a pull content transmitter configured to transmit the information including the user's content viewing or generating activities;
a central processing system configured to interact with the pull content system;
a data storage configured to store the information including the user's content viewing or generating activities; and
a user interface configured to display the information including the user's content viewing or generating activities.

7. The pull content system in claim 6, wherein:
the information including the user's content viewing or generating activities is identified by hashtags; and
the hashtags are processed by the personal digital engine according to tags.

8. A push content system for generating content from a user's content viewing or generating activities, comprising:
a push content transmitter configured to receive information including the user's content viewing or generating activities;
a push content processor configured to search for content according to the information including the user's content viewing or generating activities; and
a push content organizer configured to post content according to the information including the user's content viewing or generating activities;
a central processing system configured to interact with the push content system;
a data storage configured to store the information relevant to the user's content viewing or generating activities; and
a user interface configured to display the information including the user's content viewing or generating activities.

9. The push content system in claim 8, wherein:
the information including the user's content viewing or generating activities is identified by the hashtags; and
the hashtags are processed by the personal digital engine according to tags.

10. A loyalty points system for generating loyalty points for a user according to the user's content viewing or generating activities, comprising:
a loyalty points transmitter configured to receive information including the user's content viewing or generating activities;
a loyalty points processor configured to generate loyalty points for the user based on the information including the user's content viewing or generating activities; and
a loyalty points organizer configured to post loyalty points for the user based on the information including the user's content viewing or generating activities;
a central processing system configured to interact with the loyalty points system;
a data storage configured to store the information including the user's content viewing or generating activities; and
a user interface configured to display the information including the user's content viewing or generating activities.

11. The loyalty points system in claim 10, wherein:
the information including the user's content viewing or generating activities is identified by hashtags; and
the hashtags are processed by the personal digital engine according to tags.

12. A method for monitoring and processing content from a user's content viewing or generating activities and generating information including the user's content viewing or generating activities, comprising:
monitoring the content from a user's content viewing or generating activities;
processing the content from a user's content viewing or generating activities and generate the information including the user's content viewing or generating activities; and
transmitting the information including the user's content viewing or generating activities.

13. A method for generating content from a user's content viewing or generating activities, comprising:
receiving information including the user's content viewing or generating activities;
searching for content according to the information including the user's content viewing or generating activities; and
posting content according to the information including the user's content viewing or generating activities.

14. A method for generating loyalty points for a user according to the user's content viewing or generating activities, comprising:
receiving information including the user's content viewing or generating activities;
generating loyalty points for the user based on the information including the user's content viewing or generating activities; and
posting loyalty points for the user based on the information including the user's content viewing or generating activities.
